(19) United States
(12) Patent Application Publication
(10) Pub. No.: US 2025/0334858 A1
(43) Pub. Date: Oct. 30, 2025

(54) LENS APPARATUS, IMAGE PICKUP APPARATUS AND CAMERA APPARATUS

(71) Applicant: CANON KABUSHIKI KAISHA, Tokyo (JP)

(72) Inventor: NOBUYUKI NAGAOKA, Tochigi (JP)

(21) Appl. No.: 19/174,200

(22) Filed: Apr. 9, 2025

(30) Foreign Application Priority Data
Apr. 25, 2024 (JP) 2024-071100

(51) Int. Cl. G03B 13/34; G02B 7/14; G03B 5/00

(52) U.S. Cl. CPC G03B 13/34; G02B 7/14; G03B 5/00; G03B 2205/0046

(57) ABSTRACT

A lens apparatus, includes: a plurality of lens units movable in an optical axis direction; a plurality of driving units configured to move the plurality of lens units; an acquisition unit that acquires one or more first optical performances selected from a plurality of optical performances by a user; and a control unit configured to control the plurality of driving units, in which the control unit sets a plurality of loci of the plurality of lens units, along which the plurality of lens units are to be moved when driven by the plurality of driving units, based on one or more target values for each of the one or more first optical performances.

### BACKGROUND

### Technical Field

The present disclosure relates to a lens apparatus, an image pickup apparatus and a camera apparatus.

### Description of the Related Art

Conventionally, in a zoom lens, it is known that an angle of view of an image changes due to driving of a focus lens by performing a focus operation. In photographing in which a focus in an image is changed from a certain object to another object with no zooming operation being performed, the image may move due to a change in the angle of view caused by the focus operation.

Japanese Patent Application Laid-Open No. H10-282396 discloses a technique for suppressing a change in angle of view by driving not only a focus lens but also a zoom lens at the time of a focus operation.

Japanese Patent Application Laid-Open No. 2012-145931 discloses a technique for controlling positions of a zoom lens and a focus lens so that the angle of view changes only by a zoom operation even during simultaneous zoom and focus operations.

### SUMMARY

According to an embodiment of the present disclosure, a lens apparatus, includes: a plurality of lens units movable in an optical axis direction; a plurality of driving units configured to move the plurality of lens units; an acquisition unit that acquires one or more first optical performances selected from a plurality of optical performances by a user; and a control unit configured to control the plurality of driving units, in which the control unit sets a plurality of loci of the plurality of lens units, along which the plurality of lens units are to be moved when driven by the plurality of driving units, based on one or more target values for each of the one or more first optical performances.

According to the present disclosure, it is possible to provide a lens apparatus capable of reducing a change in an unintended optical performance item when a movable optical unit is driven.

Further features of the present disclosure will become apparent from the following description of exemplary embodiments with reference to the attached drawings.

### BRIEF DESCRIPTION OF THE DRAWINGS

FIG. 1 illustrates a system configuration of a lens apparatus and a camera apparatus according to a first embodiment.

FIG. 2 is a diagram illustrating an example of a liquid crystal display when a first optical performance is selected in the first embodiment.

FIG. 3 is a diagram illustrating an example of a liquid crystal display when a first optical performance is selected in the first embodiment.

FIG. 4 is a diagram illustrating an example of a liquid crystal display when a second optical performance is selected in the first embodiment.

FIG. 5 is a diagram illustrating an example of the liquid crystal display at a time of setting a target value of the first optical performance in the first embodiment.

FIG. 6 is a flowchart in an optical performance selection mode according to the first embodiment.

### DESCRIPTION OF THE EMBODIMENTS

Hereinafter, preferred embodiments of the present disclosure will be described in detail with reference to the accompanying drawings.

### Embodiment 1

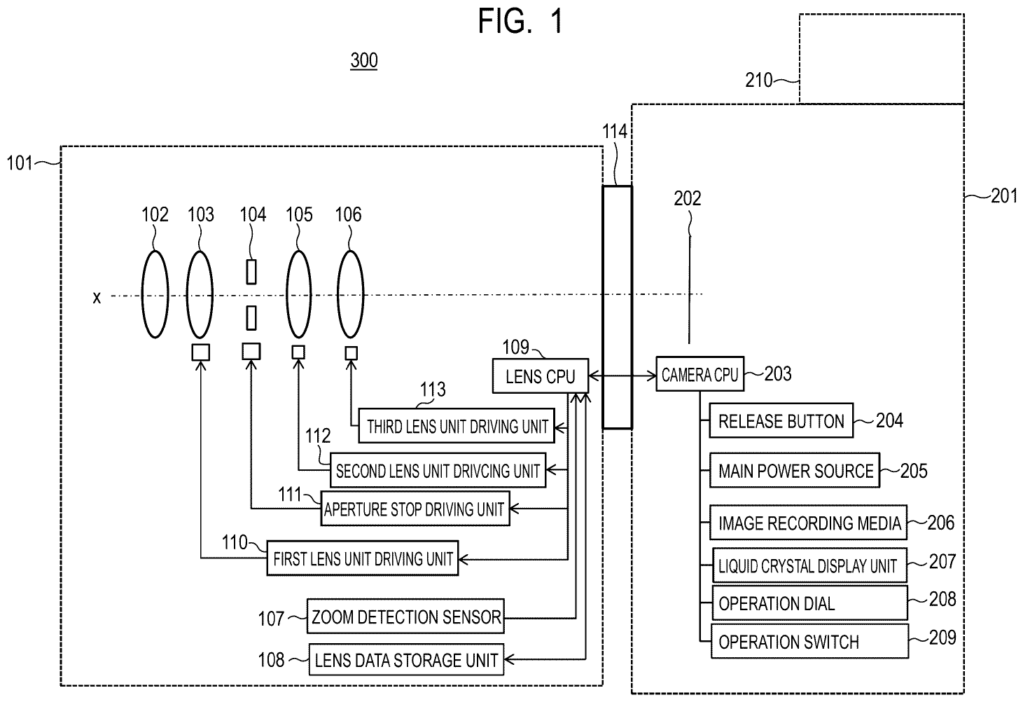

A system configuration of an image pickup apparatus 300 according to a first embodiment of the present disclosure will be described with reference to FIG. 1.

An image pickup apparatus 300 according to the first embodiment includes a lens apparatus 101 and a camera apparatus 201 that picks up an image formed by the lens apparatus 101. The lens apparatus 101 includes a fixed lens unit 102, a first movable lens unit 103, an aperture stop unit 104, a second movable lens unit 105, and a third movable lens unit 106.

In the description of the present specification, it is assumed that the “lens units” is defined by an interval between adjacent lens units being changed during at least one of zooming or focusing. Further, it should be noted that the “lens unit” is not limited to a case of being composed of a plurality of lenses and includes a case of being composed of one lens.

The lens apparatus 101 further includes a zoom ring (not shown), a zoom detection sensor 107 that detects a rotation of the zoom ring, a lens data storage unit 108, and a lens CPU (lens control unit) 109. The lens data storage unit 108 stores a plurality of sensitivities of the optical performance items of each lens unit and movement loci which are loci along which lens units are to be moved when driven by the driving units. The lens CPU 109 is a control unit that performs drive control and calculation of the entire lens apparatus.

The lens CPU 109 outputs commands to the first lens unit driving unit 110, to the second lens unit driving unit 112, and to the third lens unit driving unit 113 to control driving of the first movable lens unit 103, the second movable lens unit 105, and the third movable lens unit 106 in the direction of the optical axis X, respectively.

The first lens unit driving unit 110, the second lens unit driving unit 112, and the third lens unit driving unit 113 can drive the first movable lens unit 103, the second movable lens unit 105, and the third movable lens unit 106 independently of each other. Here, being drivable independently of each other means being drivable so as to change the distance between adjacent lens units during at least one of zooming or focusing.

Further, the lens CPU 109 outputs a command to the aperture stop driving unit 111 to drive the aperture stop unit 104 to control an aperture amount. A position sensor (not shown) is provided for each lens unit, and the position of each lens unit can be detected.

The lens apparatus 101 and the camera apparatus 201 are detachably mounted to each other via a mount 114 to constitute the image pickup apparatus 300. An image of a subject is formed by the lens apparatus 101 on an image pickup element 202 held by the camera apparatus 201, and the image is picked up by the image pickup element 202.

The camera apparatus 201 includes a camera CPU (camera control unit) 203, a release button 204, a main power supply 205, an image recording medium 206, a liquid crystal display unit 207, an operation dial 208, an operation switch 209, and a finder 210.

The release button 204 has a two-stage pressing configuration, and the first stage is referred to as half-pressing and the second stage is referred to as full-pressing. In the half-pressed state of the release button 204, preparations for starting photographing, such as returning from a photographing standby state, starting of shake correction processing, starting of autofocus, and starting of photometry, are performed. In the full-pressed state of the release button 204, picking up an image is performed and an instruction to record an image on the image recording medium 206 is output.

Through a contact block (not shown) provided in the mount 114, power is supplied from the camera apparatus 201 to the lens apparatus 101 and communication of an image pickup information is performed between the lens CPU 109 and the camera CPU 203.

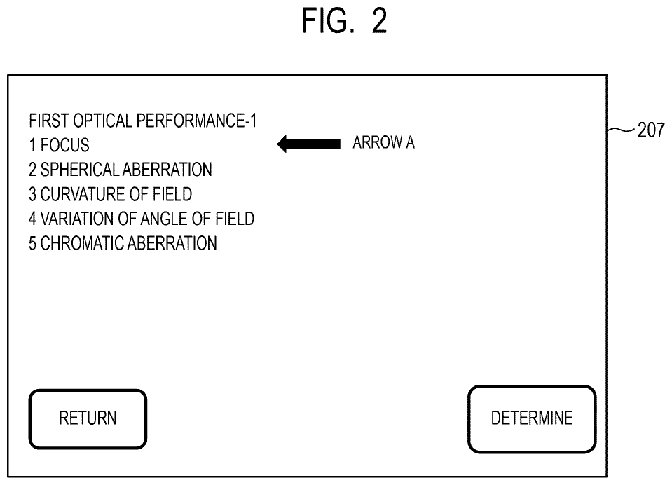

Next, a lens system unit which is characteristic of the present disclosure will be described with reference to FIGS. 2 to 6.

In the lens apparatus 101, various kinds of optical sensitivity information including a focus sensitivity, a spherical aberration sensitivity, a field curvature sensitivity, an angle-of-view variation sensitivity, and a chromatic aberration sensitivity, which is a plurality of optical performance items indicating optical performance, are stored in the lens data storage unit 108 for each lens unit. Here, the sensitivity indicates the amount of change in the state of each optical performance when each lens unit movable in the optical axis direction is moved by a unit length in the optical axis direction.

The lens data storage unit 108 stores a movement locus table indicating a basic movement locus of each lens unit during focusing and zooming and a driving speed table (movement speed table) indicating a basic driving speed (basic movement speed). At the time of focusing and at the time of zooming, the movement locus table and the driving speed table are read from the lens data storage unit 108, and a target position of each lens unit is set. The lens CPU 109 outputs a command to a driving unit of each lens unit based on the set target position to drive each lens unit.

FIG. 2 shows a first pattern of a liquid crystal display at the time of optical performance selection in the present embodiment. In the present embodiment, five optical performance items including focus, spherical aberration, curvature of field, variation in angle of view, and chromatic aberration are defined as candidates for optical performance that can be selected as the first optical performance. As the first optical performance, an optical performance item in which sensitivity information is stored in the lens data storage unit 108 can be selected. In the present embodiment, although the field curvature sensitivity is selected from among the five optical performance items, the field curvature sensitivity may be decomposed into the sagittal field curvature and the meridional field curvature to be subdivided, or another optical performance item that changes due to the movement of the lens movable in the optical axis direction may be added.

The camera apparatus 201 includes a liquid crystal display unit 207 serving as a selection input unit to which a user's instruction is input by being operated by the user and serving as a touch panel in which an optical performance item to be prioritized is selected from a menu screen. The user can select a plurality of desired first optical performances by selecting an optical performance item on the liquid crystal display unit 207.

Here, the first optical performance is an item of optical performance for which a priority is given to when controlling to minimize unintended changes in optical performance that occur, for example, when the focus optical system moves in the optical axis direction during focus operation. The first optical performance corresponds to, for example, at least one of spherical aberration, curvature of field, variation in angle of view, and chromatic aberration. Here, the control that minimizes the change is not limited to a control that does not allow the change and may be a control that limits the change amount to a predetermined allowable range.

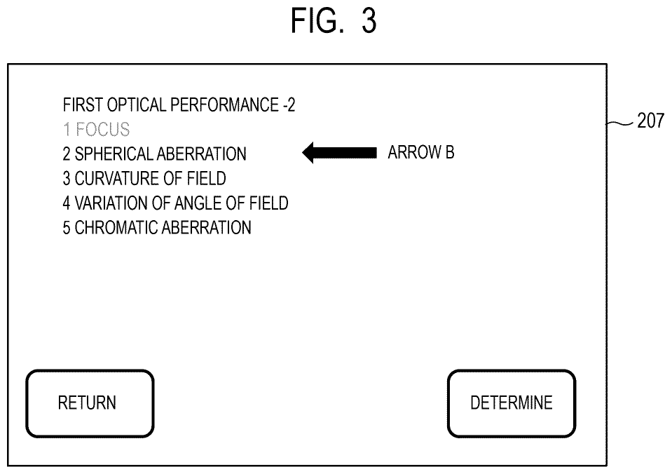

As shown in FIG. 2, at the time of selection, an arrow A is moved to a position representing a selection item on the screen of the first optical performance-1, and selection and decision are performed by an operation on the liquid crystal display unit 207 of the camera apparatus 201. After the first item is selected on the screen of the first optical performance-1, the screen shifts to a selection screen (first optical performance-2) for a second item of the first optical performance, the arrow B is moved to a position representing a second item to be selected as shown in FIG. 3, and then selection and decision are performed by an operation on the liquid crystal display unit 207.

In addition, in the present embodiment, it is possible to provide priority order with the items other than the selected first optical performance. The liquid crystal display unit 207 having the touch panel function is used as the priority setting unit, and the selection of the second optical performance and the setting of priority order thereof are performed for the items other than the optical performance item(s) selected as the first optical performance.

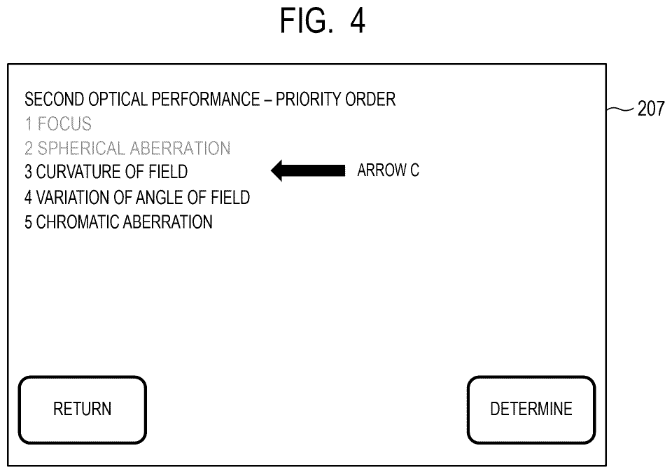

As shown in FIG. 4, by an operation on the liquid crystal display unit 207 of the camera apparatus 201, an arrow C is moved to a position representing a selection item, and a selection and a decision can be performed.

By making it possible to set the priority order of the second optical performance, it is possible to control how the aberration appears to some extent even if the change in the aberration of the second optical performance cannot be eliminated.

In principle, it is not possible to control the optical performance items, as the first optical performance, more than the number of lens units that are independently drivable. However, by making it possible to set the priority order as the second optical performance with respect to the optical performance item for which the unintended change is desired to be suppressed as much as possible, it is possible to perform control so that the unintended change in the performance among the second optical performances other than the first optical performance is preferentially minimized.

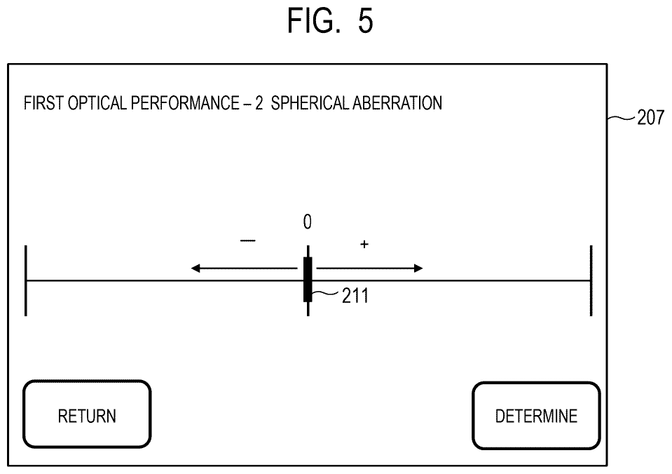

Further, as shown in FIG. 5, with respect to the first optical performance, by operating the scroll bar 211 on the liquid crystal display unit 207 as the target value setting unit, the target value can be arbitrarily set to the minimum value (0), a predetermined positive value, or a predetermined negative value.

By setting the target value of the selected first optical performance to a minimum value, it is possible to set the setting advantageous for the second priority optical performance by the user, and thus it is possible to respond to various user's demands with one lens apparatus. Further, by making it possible to set the optical performance items for a mode of shooting a moving image and for a mode of shooting a still image, respectively, it is possible to select an optical performance item according to a situation of shooting as the first optical performance, and it is possible to automatically reflect the selected first optical performance at the time of mode change.

It is also possible to change the respective target values of the first optical performance to the positive side and the negative side. Therefore, for example, the technique of widening the range of representation by allowing the user to change the spherical aberration has been conventionally realized only in a part of the interchangeable lenses, but by adopting the present disclosure, it is possible to realize the effect of widening the representation by many interchangeable lenses.

Further, since the optical performance items other than the spherical aberration can be set as the first optical performance in the same manner, it is possible to realize an imaging representation that has not been achieved so far.

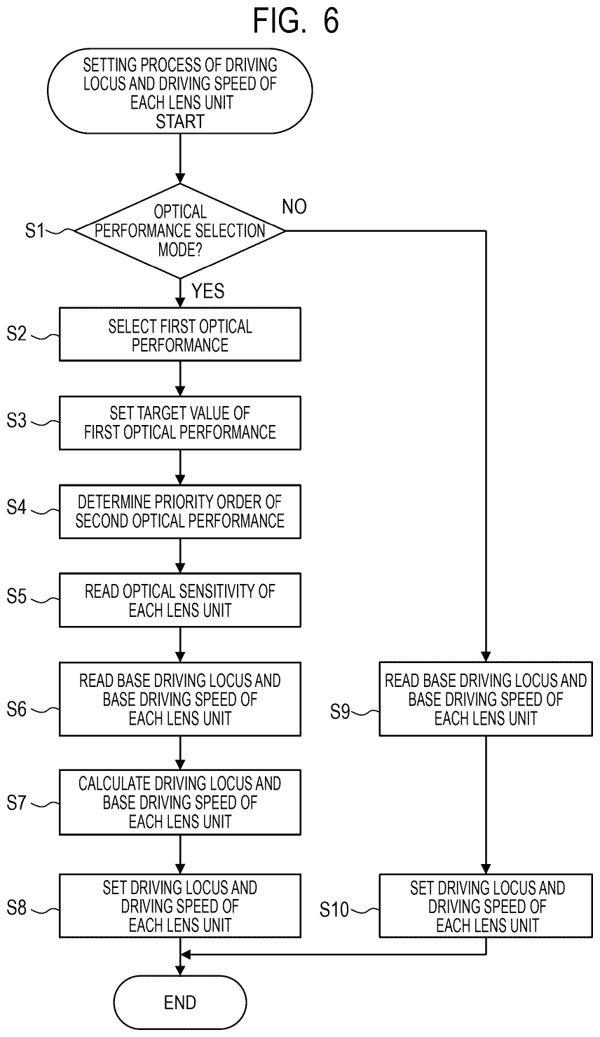

Next, processing for setting the movement locus and the driving speed of each lens unit by the control unit (lens CPU 109) will be described with reference to a flowchart illustrated in FIG. 6.

First, when the process is started, the process proceeds to step S1, it is determined whether or not the mode is the optical performance selection mode. When the mode is the optical performance selection mode, the process proceeds to step S2, and when the optical performance selection mode is not selected, the process proceeds to step S9.

In step S9, the basic movement locus and the basic driving speed of each lens unit stored in advance in the lens data storage unit 108 of the lens apparatus 101 are read, and the mode is shifted to the image pickup mode in which focus driving and zoom driving are performed in accordance with the basic movement locus and the basic driving speed.

Here, the basic movement locus and the basic driving speed are set in advance in accordance with a predetermined calculation rule as basic information related to the movement of each lens unit at the time of focusing and zooming when the optical performance selection mode is not selected. However, the basic movement locus and the basic driving speed may be appropriately changed and set as necessary.

In step S2, an optical performance item is selected for the first optical performance. The first optical performance is selected from, for example, the above-described five optical performance items (focus, spherical aberration, curvature of field, variation in angle of view, and chromatic aberration). In the present embodiment, since the first movable lens unit 103, the second movable lens unit 105, and the third movable lens unit 106 move during focusing, the number of optical performance items that can be selected as the first optical performance is two or less. After the first optical performance is selected in step S2, the process proceeds to step S3.

In the present embodiment, the selection of the first optical performance is performed on the liquid crystal display unit 207 which is a touch panel provided in the camera apparatus 201, and the lens CPU (acquisition unit) 109 acquires the information of the selected first optical performance by communication via the mount 114.

In step S3, the target value for the selected first optical performance is set. As described with reference to FIG. 5, the target value is set and determined for the first optical performance by operating the scroll bar 211.

In the present embodiment, the setting the target value is performed by using a variable scroll bar, but can be performed by inputting of a numerical value or by selecting a mode having a preset value or preset values.

Next, the process proceeds to step S4, and the second optical performance is selected from the optical performance items other than the first optical performance selected in step S3.

Next, the process proceeds to step S5, and various kinds of optical sensitivity information of each lens unit necessary for calculation of the movement locus and the driving speed of each lens unit are read from the lens data storage unit 108, such that each of the first optical performances has a predetermined value or has a value restricted within a predetermined range.

Next, the process proceeds to step S6, and the basic movement locus and the basic driving speed of each lens unit necessary for the calculation are read from the lens data storage unit 108.

Next, the process proceeds to step S7, and the lens CPU 109 serving as the movement locus setting unit calculates the driving speed and the movement locus of each lens unit based on the first optical performance(s), the target values of the first optical performance(s), various kinds of optical sensitivity information, the basic movement loci, and the basic driving velocities.

Here, the driving speed and the movement locus of each lens unit are acquired by correcting the basic movement locus and the basic driving velocity in accordance with the respective target values of the first optical performances, but may be calculated from only the first optical performance, the target values of the first optical performance, and various kinds of optical sensitivity information.

In the calculation of the driving speed of each lens unit in step S7, since there are a lowest driving speed and a highest driving speed that can be driven by each actuator constituting the driving unit of each lens unit, it is necessary to set the driving speed of each lens unit in consideration of the lowest driving speed and the highest driving speed.

In a case where the driving unit is configured by an actuator which has a high minimum driving speed and cannot perform a low speed driving, there is a concern that synchronous driving cannot be performed when the respective lens units are simultaneously driven, and that an intermittent driving such that a lens unit driven by the actuator is driven ahead and then waits for the other lens units to follow. In such a case, there is a concern that the influence of the intermittent driving appears in the video at the time of picking up the moving image, and the unnaturalness becomes conspicuous.

Therefore, it is possible to smoothly drive all the lens units by performing the calculation so that the driving speed required for each actuator of the driving unit in the synchronous driving is set to be equal to or higher than the minimum driving speed of each actuator.

In addition, in a case where the driving unit is configured by an actuator which has a low maximum driving speed and cannot perform a high speed driving, there is a concern that synchronous driving cannot be performed when the respective lens units are simultaneously driven, and that the driving of the lens unit by the driving unit is delayed. In this case, there is a concern that the image quality may deteriorate in aberration, focus, and angle of view of the image at the time of picking up the moving image.

Therefore, it is possible to drive all the lens units at the same time by performing the calculation so that the driving speed required for each actuator of the driving unit in synchronous driving is set to be equal to or lower than the maximum driving speed of each actuator.

Further, in the present embodiment, the movement locus and the driving speed are set by the calculation, but the present disclosure is not limited thereto. All tables of the movement locus and the driving speed according to the selected first optical performance and the target value may be prepared, stored in the lens data storage unit 108, and read to be used.

Next, in step S8, the movement locus and the driving speed calculated in step S7 are set, and the process ends.

In step S9 which is branched from step S1, the basic movement locus and the basic driving speed of each lens unit are read from the lens data storage unit 108, and the process proceeds to step S10. As described above, the basic movement locus and the basic driving speed are set in advance in accordance with a predetermined calculation rule as basic information related to the movement of each lens unit at the time of focusing and zooming when the optical performance selection mode is not selected.

In step S10, the basic movement locus and the basic driving speed read out in step S9 are set as drive information of each lens unit at the time of focusing and zooming, and the process ends.

At the time of subsequent focusing or zooming, by driving each lens unit in accordance with the set movement locus and driving speed, it is possible to realize driving of each lens unit in accordance with the selected optical parameter.

In the optical performance selection mode, either two or three lens units among the three movable lens units may be the lens units whose movement loci and driving speed are to be changed.

In addition, in the present embodiment, two optical performance items are selectable for the first optical performance, but it is possible to further expand the application range by making it possible to select optical performance items, as the first optical performance, up to the same number as the number of lens units that can move in the optical axis direction.

Alternatively, since there is a high possibility that the focus included in the optical performance items is always selected as the first optical performance, one or more optical performance items may be selected as selectable first optical performance item from the optical performance items other than focus.

In the present exemplary embodiment, the calculation processing of the movement locus and the driving speed is performed in the lens apparatus 101, but the calculation processing may be performed in the camera apparatus 201.

Although the selection of the first optical performance, the setting of the target value of the first optical performance, and the selection of the second optical performance is performed by use of the liquid crystal display unit 207 in the camera apparatus 201 and is input to the lens apparatus 101 via the mount having the input unit (receiving unit) from an output unit (transmitting unit) of the camera apparatus (external device), the present disclosure is not limited thereto. Other than the camera apparatus 201, for example, a user interface provided in the lens apparatus 101 or a drive unit connected to the lens apparatus to drive the movable lens unit may be used for the setting.

Although the target value corresponding to the first optical performance can be selected by the user, the target value may be set in advance in the lens apparatus 101 or the camera apparatus 201, and the user may only select the first optical performance from the optical performance items to thereby simply perform the setting.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-071100, filed Apr. 25, 2024, which is hereby incorporated by reference herein in its entirety.

What is claimed is:

1. A lens apparatus, comprising:
a plurality of lens units movable in an optical axis direction;
a plurality of driving units configured to move the plurality of lens units;
an acquisition unit that acquires one or more first optical performances selected from a plurality of optical performances by a user; and
a control unit configured to control the plurality of driving units,
wherein the control unit sets a plurality of loci of the plurality of lens units, along which the plurality of lens units are to be moved when driven by the plurality of driving units, based on one or more target values for each of the one or more first optical performances.

2. The lens apparatus according to claim 1, comprising an input unit configured to allow the user to select the one or more first optical performances from the plurality of optical performances.

3. The lens apparatus according to claim 1, comprising a setting unit configured to set the one or more target values.

4. The lens apparatus according to claim 1, comprising a receiving unit configured to receive the one or more target values from an external device.

5. The lens apparatus according to claim 1, wherein the control unit calculates the plurality of loci of the plurality of lens units based on the one or more target values.

6. The lens apparatus according to claim 1, comprising a storage unit configured to store the plurality of loci,
wherein the control unit acquires the plurality of loci from the storage unit based on the one or more first optical performances and the one or more target values of the one or more first optical performances and sets the plurality of loci.

7. The lens apparatus according to claim 1, comprising a setting unit configured to set a priority order for optical performances other than the one or more first optical performances among the plurality of optical performances,
wherein the control unit sets the plurality of loci of the plurality of lens units based on the priority order.

8. The lens apparatus according to claim 1, wherein a number of each of the plurality of lens units and the plurality of driving units is three or more.

9. The lens apparatus according to claim 1, comprising a setting unit configured to set the one or more target values by a user.

10. The lens apparatus according to claim 1, wherein the plurality of loci are loci for focusing.

11. The lens apparatus according to claim 1, wherein the plurality of loci are loci for zooming.

12. An image pickup apparatus, comprising:
the lens apparatus according to claim 1; and
an image pickup element configured to pick up an image formed by the lens apparatus.

13. A camera apparatus, to which the lens apparatus according to claim 1 can be detachably mounted, comprising an image pickup element that picks up an image formed by the lens apparatus.

14. The camera apparatus according to claim 13, comprising:
an input unit configured to allow the user to select the one or more first optical performances from the plurality of optical performances;
a setting unit configured to set the one or more target values; and
a transmitting unit configured to transmit the one or more first optical performances and the one or more target values to the lens apparatus.
